(19) United States
(12) Patent Application Publication
(10) Pub. No.: US 2026/0281068 A1
(43) Pub. Date: Sep. 17, 2026

(54) SYSTEMS AND METHODS FOR DEFERRED TOOL EXECUTION

(71) Applicant: Shopify Inc., Ottawa (CA)

(72) Inventor: Ates GÖRAL, Toronto (CA)

(73) Assignee: Shopify Inc., Ottawa (CA)

(21) Appl. No.: 19/227,665

(22) Filed: Jun. 4, 2025

Related U.S. Application Data
(60) Provisional application No. 63/773,049, filed on Mar. 17, 2025.

(51) Int. Cl. H04L 51/046; H04L 51/216

(52) U.S. Cl. CPC H04L 51/046; H04L 51/216

(57) ABSTRACT

A first connection is established between a client device and server. The client sends a user query (a first message) to the server and the server sends a first prompt based thereon to a LLM. In response, the LLM invokes a tool call for execution by the client device. The server transmits the tool call to the client device and the first connection is closed. The client executes the tool call. A second connection is established between the client device and server. The client device sends a second message to the server. The server determines that the second message includes a tool response in reply to the tool call and transmits a message including the tool response and at least a portion of stored conversation history to the LLM. The LLM sends an assistant message in reply and the server transmits a first assistant message to the client device.

### CROSS-REFERENCE TO RELATED APPLICATIONS

The present application claims priority to U.S. Provisional Patent Application No. 63/773,049 filed on Mar. 17, 2025, the contents of which are herein incorporated by reference in their entirety.

### TECHNICAL FIELD

The present disclosure relates to Large Language Models (LLMs) and, more particularly, methods for LLMs to interact with external data sources via tool calling functionality.

### BACKGROUND

Tool calling is a structured way to give Large Language Models (LLMs) the ability to make requests back to the application that called it. A server prompts an LLM with a user query. Tool definitions are provided with a prompt, defining the structure and parameters of tools that the LLM can interact with, enabling it to perform specific tasks. Data provided in response to a tool call allows the LLM to respond to a prompt with information not directly accessible by the LLM.

### BRIEF DESCRIPTION OF THE DRAWINGS

Reference will now be made, by way of example only, to the accompanying drawings which show example embodiments of the present application, and in which:

FIG. 1A illustrates a simplified block diagram of a network environment in which a LLM may be deployed;

FIG. 1B illustrates a high-level diagram of an example computing device;

FIG. 1C illustrates a simplified example of software components stored within the computing device;

FIG. 2 illustrates an exemplary message sequence diagram associated with a LLM tool calling process according to prior art;

FIG. 3 illustrates an exemplary message sequence diagram associated with a LLM client-side tool calling process;

FIG. 4 illustrates is a simplified block diagram of an exemplary method for calling a client tool by a by a LLM according to an embodiment; and

FIG. 5 illustrates an exemplary message sequence diagram associated with a LLM client-side tool calling process according to an embodiment.

Like reference numerals are used in the drawings to denote like elements and features.

### DETAILED DESCRIPTION OF IMPLEMENTATIONS

In accordance with one aspect, the present application discloses a computer-implemented method, comprising, establishing, at a server, a first connection between a client device and the server in response to receiving a first request from the client device, transmitting, based on a first message from the client device, a first prompt from the server to a large language model (LLM) and, in response, receiving a tool call from the LLM, determining that the tool call is a client-side tool call and transmitting, via the first connection, the tool call and a conversation identifier to the client device in response to the first message, closing the first connection and storing a conversation history object in memory at the server in association with the conversation identifier, establishing, at the server, a second connection with the client device in response to receiving, from the client device, a second request, retrieving the conversation history object from memory based on the conversation identifier in response to receiving, from the client device, a second message and the conversation identifier, determining, based in part on the conversation history object, that the second message includes a tool response in reply to the tool call and transmitting to the LLM a third message including the tool response and at least a portion of the conversation history object, and receiving a first assistant message from the LLM in reply to the third message and transmitting the first assistant message to the client device.

In some implementations, determining that the tool call is a client-side tool call includes processing, by the server, the tool call and determining it references a function executable by the client device. In some implementations, determining the second message includes a tool response in reply to the tool call based in part on the conversation history object includes determining, from the conversation history object, that a next expected response from the client device is a tool response type message. In some implementations, closing the first connection occurs without transmitting an assistant response message in reply to the first message from the client device. In some implementations, the method further comprises, executing, at the client device, a tool function in response to receipt of the tool call from the server and wherein the tool function produces content for the tool response.

In some implementations, the method further comprises, establishing, at the server, a third connection between the client device and the server in response to receiving a third request from the client device and a fourth message containing a second prompt, assigning a further conversation identifier and initializing a further conversation history object for storing conversation history, and transmitting the third message to the LLM, receiving a second assistant message from the LLM in reply to the third message, and transmitting the second assistant message and the further conversation identifier to the client device.

In some implementations, the method further comprises, opening a HTTP session over the first connection between the client device and the server. In some implementations, closing the first connection releases a port on the server associated with the HTTP session.

In accordance with another aspect, the present application discloses a computing device comprising, one or more processors, and at least one memory storing processor-executable instructions, wherein the processor-executable instructions, when executed, are to cause the one or more processors to, establish, at a server, a first connection with a client device in response to receiving a first request from the client device, transmit, based on a first message from the client device, a first prompt from the server to a large language model (LLM) and, in response, receive a tool call from the LLM, determine that the tool call is a client-side tool call and transmit, via the first connection, the tool call and a conversation identifier to the client device in response to the first message, close the first connection and store a conversation history object in memory in association with the conversation identifier, open a second connection with the client device in response to receiving, from the client device, a second request, retrieve the conversation history object from memory based on the conversation identifier in response to receiving, from the client device, a second message and the conversation identifier, determine, based in part on the conversation history object, that the second message includes a tool response in reply to the tool call and transmit to the LLM a third message including the tool response and at least a portion of conversation history, and receive a first assistant message from the LLM in reply to the third message and transmits the first assistant message to the client device.

In some implementations, determining that the tool call is a client-side tool call includes processing the tool call and determining it references a function executable by the client device. In some implementations, determining the second message includes a tool response in reply to the tool call based in part on the conversation history object includes determining, from the conversation history, that a next expected response from the client device is a tool response type message. In some implementations, closing the first connection occurs without transmitting an assistant response message in reply to the first message from the client device.

In some implementations, the processor-executable instructions, when executed, further cause the one or more processors to, establish, at the server, a third connection between the client device and the server in response to receiving a third request from the client device and a fourth message containing a second prompt, assign a further conversation identifier and initialize a further conversation history object for storing conversation history, and transmit the third message to the LLM, receive a second assistant message from the LLM in reply to the third message, and transmit the second assistant message and the further conversation identifier to the client device.

In some implementations, the processor-executable instructions, when executed, further cause the one or more processors to open a HTTP session over the first connection between the client device and the server. In some implementations, closing the first connection releases a port on the server associated with the HTTP session.

In accordance with another aspect, the present application discloses a non-transitory computer-readable medium storing processor-executable instructions that, when executed by one or more processors, are to cause the one or more processors to, establish, at a server, a first connection between a client device and the server in response to receiving a first request from the client device, transmit, based on a first message from the client device, a first prompt from the server to a large language model (LLM) and, in response, receive a tool call from the LLM, determine that the tool call is a client-side tool call and transmit, via the first connection, the tool call and a conversation identifier to the client device in response to the first message, close the first connection and store a conversation history object in memory at the server in association with the conversation identifier, open, at the server, a second connection with the client device in response to receiving, from the client device, a second request, retrieve the conversation history object from memory based on the conversation identifier in response to receiving, from the client device, a second message and the conversation identifier, determine, based in part on the conversation history object, that the second message includes a tool response in reply to the tool call and transmit to the LLM a third message including the tool response and at least a portion of conversation history, and receive a first assistant message from the LLM in reply to the third message and transmits the first assistant message to the client device.

In some implementations, determining that the tool call is a client-side tool call includes processing the tool call and determining it references a function executable by the client device. In some implementations, determining the second message includes a tool response in reply to the tool call based in part on the conversation history object includes determining, from the conversation history, that a next expected response from the client device is a tool response type message. In some implementations, closing the first connection occurs without transmitting an assistant response message in reply to the first message from the client device.

In some implementations, the non-transitory computer-readable medium storing processor-executable instructions, when executed by one or more processors, further cause the one or more processors to, establish, at the server, a third connection between the client device and the server in response to receiving a third request from the client device and a fourth message containing a second prompt, assign a further conversation identifier and initialize a further conversation history object for storing conversation history, and transmit the third message to the LLM, receive a second assistant message from the LLM in reply to the third message, and transmit the second assistant message and the further conversation identifier to the client device.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

A Large Language model (LLM) is a type of machine learning model designed for natural language processing (NLP) tasks. Having the ability to understand and generate human language, LLMs can generate text, translate between different languages, condense large amounts of data into concise summaries, and answer questions, among other NLP tasks. A LLM receives a user prompt, also referred to herein as a prompt, and based on their internal structure and training, the LLM provides a response known as an assistant message, also referred to herein as an assistant. Should the model not have sufficient information to provide a complete response, the model is capable of tool calling, also known as function calling, to obtain information to provide an adequate response to a prompt.

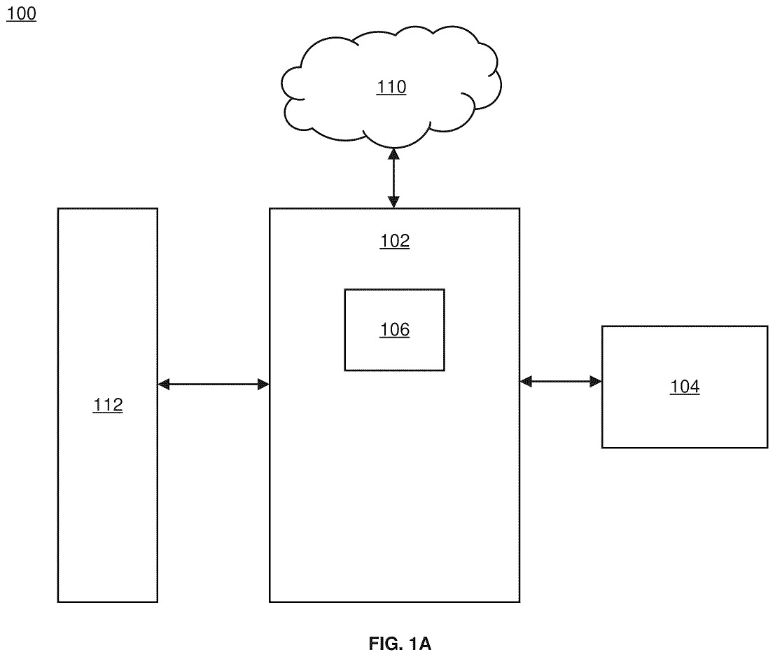

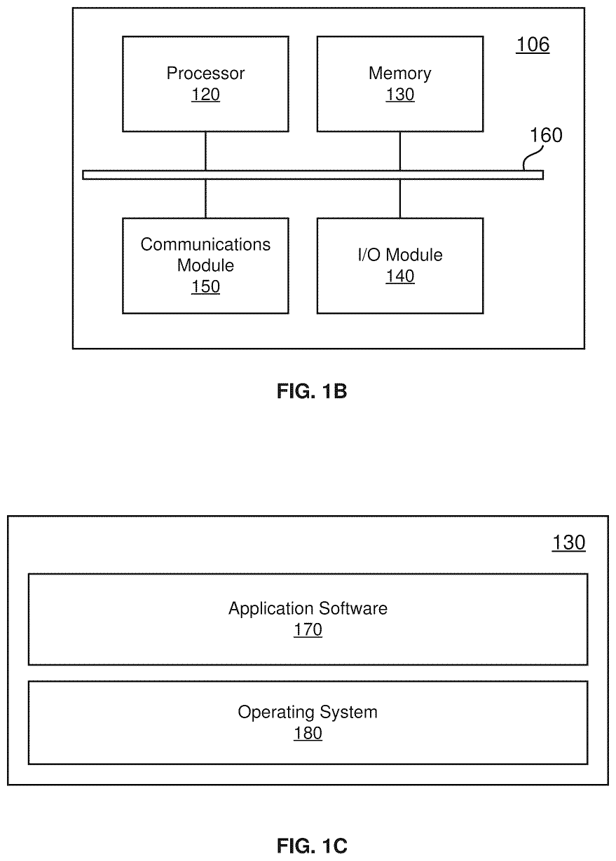

Illustrated in FIG. 1A is a simplified block diagram of a network environment 100 in which a LLM may be deployed. Shown is a client-server configuration for use of an LLM including server 102. Server 102 includes example computing device 106. FIG. 1B shows a high-level diagram of an example computing device 106. The example computing device 106 includes a variety of modules. For example, the example computing device 106 may include a processor 120, a memory 130, an I/O module 140, and a communications module 150. As illustrated, the foregoing example modules of the example computing device 106 are in communication over a bus 160.

The processor 120 in this example is a hardware processor. The processor 120 may, for example, be one or more ARM, Intel x86, PowerPC processors, or the like.

The memory 130 allows data to be stored and retrieved. The memory 130 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 106.

The I/O module 140 allows the example computing device 106 to receive input signals and to transmit output signal. Input signals may, for example, correspond to input received from a user. Some output signals may, for example, allow provision of output to a user. The I/O module 140 may serve to interconnect the example computing device 106 with one or more input devices. Input devices may, for example, include one or more of a touchscreen input, keyboard, trackball or the like. The I/O module 140 may serve to interconnect the example computing device 106 with one or more output devices. Output devices may include, for example, one or more display screens such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers.

The communications module 150 allows the example computing device 106 to communicate with other electronic devices and/or various communications networks. For example, the communications module 150 may allow the example computing device 106 to send or receive communications signals. As an example, the communication module 150 may include a network connection, data port, or the like. Communications signals may be transmitted or received according to one or more protocols or according to one or more standards. For example, the communications module 150 may allow the example computing device 106 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G, 6G, or the like. Additionally, or alternatively, the communications module 650 may allow the example computing device 106 to communicate using near-field communication (NFC), via Wi-Fi™, via the Ethernet family of network protocols, using Bluetooth™ or via some combination of one or more networks or protocols. In some embodiments, all or a portion of the communications module 150 may be integrated into a component of the example computing device 106. In some examples, the communications module may be integrated into a communications chipset.

Software instructions are executed by the processor 120 from a computer-readable medium. For example, software may be loaded into random-access memory from persistent storage within memory 130. Additionally, or alternatively, instructions may be executed by the processor 120 directly from read-only memory of the memory 130.

FIG. 1C depicts a simplified organization of software components stored in memory 130 of the example computing device 106. As illustrated, these software components include, at least, application software 170 and an operating system 180.

The application software 170 adapts the example computing device 106, in combination with the operating system 180, to operate as a device performing a particular function. While a single application software 170 is illustrated in FIG. 1C, in operation, the memory 130 may include more than one application software and different application software may perform different operations.

The operating system 180 is software. The operating system 180 allows the application software 170 to access the processor 120, the memory 130, the I/O module 140, and the communications module 150. The operating system 180 may, for example, be iOS™, Android™, Linux™, Microsoft Windows™, or the like.

The application software 170 and/or operating system 180 may, when executed, cause the processor 120 to carry out operations to implement at least some portion of one or more of the methods described herein.

Referring again to FIG. 1A, shown is server 102 in communication with a client device 112, a communication network 110, such as the Internet, and an instance of an LLM, LLM 104. Exemplary client devices include computers, mobile phones, tablets, and the like. Client device 112 communicates with server 102 over a communication network (not shown), such as the Internet. For ease of description LLM 104 is shown separate and apart from server 102. However, in some instances, server 102 is a LLM server that hosts LLM 104. Alternatively, LLM 104 is hosted on a second server (not shown), for instance, LLM 104 is hosted in the cloud. This client-server configuration enables client device 112 to send a user query (or instruction) to LLM 104 via intermediary server 102. Server 102 constructs a prompt based on the user query and transmits the prompt to LLM 104 for inferencing. Prompt construction structures text that can be interpreted by the LLM to elicit a desired response, i.e., assistant. Often, the prompts are sent with conversation history, such as previous prompts and respective assistants exchanged between the server and LLM during a same conversation. LLMs are stateless-each incoming prompt is processed independently from other interactions. Sending the conversation history with a prompt aids the LLM in providing a more accurate assistant. Tool definitions may also be included in a prompt to enable the LLM to invoke tools (i.e., functions) for acquiring information beyond its knowledge base. A tool definition may include a tool name, a description of what the tool does, and a schema, for example a JSON schema, defining expected input parameters for the tool, such as data types and required fields.

Upon receiving the prompt, LLM 104 determines whether it can provide a complete response, i.e., assistant, based on its internal structure or whether it requires additional information. For example, LLM 104 may analyze the prompt and determine a tool invocation is needed to fulfill the request. LLM 104 selects the appropriate tool and transmits a tool call, including the name of the tool and its arguments, to server 102. Server 102 executes the tool call and returns the result, i.e., tool response, as well as the associated conversation history to LLM 104. LLM 104 then constructs an assistant based on the received tool response and conversation history, forwards the assistant to server 102. The assistant is forwarded to client device 112 in a message from server 102.

Client-server communication is carried out over a connection, such as a Transfer Control Protocol (TCP) connection. Prior to sending a user query, client device 112 initiates a connection with server 102 and, once established, transmits a Hypertext Transfer Protocol (HTTP) request for starting a HTTP session. The HTTP protocol is an application-layer protocol for transferring hypertext messages between clients and servers whereas TCP is a transport layer protocol which enables delivery of data over a network. The HTTP protocol defines two types of messages for transmitting and receiving data, specifically, HTTP message requests and responses.

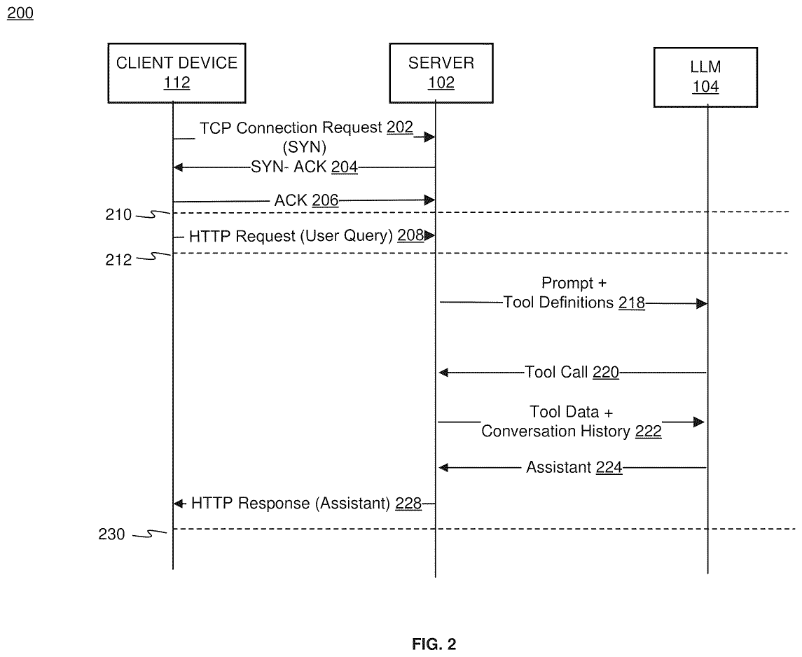

Illustrated in FIG. 2 is an exemplary message sequence diagram 200 associated with a LLM tool calling process. Messages are described with reference to FIG. 1A and FIG. 1B.

A user inputs a user query into a user interface of client device 112 for processing by LLM 104. For instance, a user navigates to the landing page of ChatGPT® and enters the user query, ‘what is the current weather in New York, NY?’ into the corresponding the text box. Client device 112 transmits a TCP connection request 202 that specifies a server communication port to server 102 initiating a TCP connection. Client device 112 and server 102 exchange a 3-way TCP three-way handshake (SYN 202, SYN-ACK 204, and SYN 206). The communication port is reserved for the TCP connection, e.g., port 80 for HTTP messages, and a TCP connection is established, as indicated by numeral 210. A HTTP request message 208, including the user query, is transmitted by client device 112 to server 102 over the TCP connection. In response, server 102 begins a HTTP session, as indicated at reference numeral 212. The HTTP session and TCP connection remain open until client device 112 has received a response, i.e., assistant, to its user query from LLM 104.

Based on the user query, ‘what is the current weather in New York, NY?’ from client device 112, server 102 constructs a prompt for processing by LLM 104. Server 102 transmits message 218 including the prompt and a list of tool definitions of functions executable by server 102, to LLM 104. Alternatively, the prompt and tool definitions are transmitted to by server 102 in separate messages. LLM 104 then analyzes the prompt and determines information from an external source, e.g., server 102, is needed to provide an assistant to the prompt. In particular, LLM 104 identifies a weather tool defined in message 218 from server 102 as an appropriate function for obtaining current weather information of a specified location. LLM 104 invokes the weather tool by transmitting a tool call 220 to server 102. Tool call 220 may include the tool name and required arguments/fields, such as the location, New York, NY. Server 102 stores the conversation history, including, for example, the latest prompt and tool call, in memory 130 for later use. Subsequent to receiving the tool call, server 102 retrieves the requested data, also referred to herein as tool response. Retrieving current weather data may include executing an application programming interface (API) call for connecting to an external service accessible via communication network 110, e.g., the Internet. Server 102 transmits the retrieved tool response-the current weather for New York, NY,- and the corresponding conversation history in message 222 to LLM 104. Alternatively, the tool response and conversation history are transmitted to LLM 104 in separate messages. LLM 104 forms an assistant in response to the prompt, based on message 222. For example, LLM 104 generates and transmits assistant 224—‘the current weather in New York, NY is 15° and sunny’—to server 102. Next, server 102 transmits assistant 224 in HTTP response 228 to client device 112. Finally, server 102 terminates the HTTP session, closes the TCP connection, as indicated at numeral 230, and releases the communication port, e.g., port 80.

In another example, a user query may include, ‘What is 1+1?’ Based on the user query from client device 112, server 102 constructs a prompt for processing by LLM 104. Server 102 transmits message 218 including the prompt and a list of tool definitions of functions executable by server 102, to LLM 104. Alternatively, the prompt and tool definitions are transmitted by server 102 in separate messages. LLM 104 then analyzes the prompt and determines information from an external source, e.g., server 102, is needed to provide an assistant to the prompt. In particular, LLM 104 identifies a ‘calculate_sum’ tool defined in message 218 from server 102 as an appropriate function for summing two numbers. LLM 104 invokes the ‘calculate_sum’ tool by transmitting a tool call 220 to server 102. Tool call 220 may include the tool name ‘calculate_sum’ and required arguments/fields, such as the value of the two numbers to be summed, for example {‘a’: “1”, ‘b’: “1”}. Server 102 stores the conversation history, including, for example, the latest prompt and tool call, in memory 130 for later use. An exemplary tool definition for the tool ‘calculate_sum’ includes:

```
    tools: [{
name: “calculate_sum”,
  description: “Add two numbers together”,
inputSchema: {
  type: “object”,
properties: {
a: { type: “number” },
b: { type: “number” }
},
required: [“a”, “b”]
},
}]
```

Subsequent to receiving the tool call, server 102 executes the tool call and forms a tool response based on the result provided by the function. Server 102 transmits the tool response, ‘calculate sum=2’, and the corresponding conversation history in message 222 to LLM 104. Alternatively, the tool response and conversation history are transmitted to LLM 104 in separate messages. LLM 104 forms an assistant in response to the prompt, based on message 222. For example, LLM 104 generates and transmits assistant 224, ‘1+1=2’, to server 102. Next, server 102 transmits assistant 224 in HTTP response 228 to client device 112. Finally, server 102 terminates the HTTP session, closes the TCP connection, as indicated at numeral 230, and releases the communication port, e.g., port 80.

In some instances, a server may not be configured to carry out a tool call invoked by an LLM. For example, in response to receiving a prompt, a LLM may require access to information not stored on, or available to, the server directly. However, the information is accessible by a client device, such as the client device that initiated the LLM prompt.

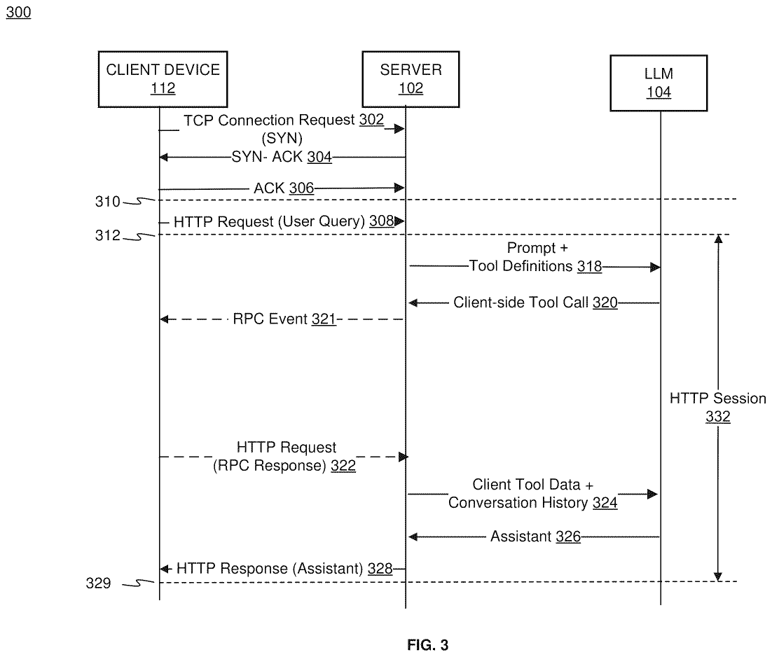

Illustrated in FIG. 3 is an exemplary message sequence diagram 300 associated with a LLM client-side tool calling process wherein a tool call is invoked on a client device. Messages are described with reference to FIG. 1A and FIG. 1B.

A user inputs a user query into a user interface of client device 112 for processing by LLM 104. For instance, a user enters a user query into a text box of a GUI integrated with a LLM application. In this example, the LLM is used for helping users of an e-commerce platform create and manage online stores. An exemplary user query may include, ‘Help me create a 15% discount code for the Black Friday sale’. Client device 112 transmits a TCP connection request 302, including a server communication port, to server 102 initiating a TCP connection. Client device 112 and server 102 exchange a TCP three-way handshake (SYN 302, SYN-ACK 304, and SYN 306). The server communication port is reserved for the TCP connection e.g., port 80 for HTTP messages, and a TCP connection is established, as indicated by numeral 310. A HTTP request message 308, including a user query for LLM 104, is transmitted by client device 112 to server 102 over the TCP connection. In response, server 102 begins a HTTP session 332, as indicated at reference numeral 312. HTTP session 332 and the TCP connection remains open until server 102 has transmitted an assistant response to the user query.

Based on the user query from client device 112, server 102 constructs a prompt for processing by LLM 104. Server 102 transmits message 318, including the prompt and a list of tool definitions of functions executable by server 102 and executable by a client device 112, to LLM 104. Alternatively, the prompt and tool definitions are transmitted to server 102 in separate messages. LLM 104 analyzes the prompt and determines information from an external source, for example, client device 112, is needed to provide an assistant to the prompt. Alternatively, LLM 104 analyzes the prompt and determines it cannot perform an operation needed to service a user query, whereas, the operation is executable by client device 112. In particular, LLM 104 identifies a specific client tool-a function executable by client device 112 -as an appropriate function for obtaining the needed information and/or for performing a task to provide a satisfactory response or result to the user query. In the present example, the LLM may identify a client-side tool called, ‘fill_form_locally’ as an appropriate tool for providing a response to the user query, ‘Help me create a 15% discount code for the Black Friday sale’. LLM 104 transmits the client-side tool call 320 to server 102. Client-side tool call 320 may include the tool name and required arguments/fields, such as a ‘fill_form_locally’ with arguments {‘route’: “mystore. com/admin/discounts/create”, ‘parameter1_name':“discount_name”, ‘parameter1_value’:“blackfriday”, ‘parameter2_name’:“discount_type”, ‘parameter2_value’:“percentage”, ‘paramater3_name’:“discount_value”, ‘parameter3_value’: “15%”}. Server 102 stores the conversation history, including, for example, the latest prompt and tool call, in memory 130 for later use.

Next, server 102 processes message 320 and determines the message includes a tool call intended for execution by client device 112. However, the existing HTTP protocol for communication between client and server for utilizing a LLM limits the client-server communication message types to prompts, from the client to server, and assistants, from server to client. There is presently no means available in the current HTTP protocol to invoke a tool call on the client and to provide a response to the tool call from the client back to the server. during the course of a single HTTP connection. One work around includes establishing a backdoor communication channel between the client and server. For instance, using server-transmitted events, the server sends a remote procedure call (RPC) event 321 to client device 112 while keeping the response channel waiting until client device 112 transmits back an RPC response through a webhook, via a second HTTP request. Server 102 would have to implement a mechanism to wake up the HTTP request 308 that is waiting for the RPC response, for example, through some inter-process communication, utilizing a cache or message queue. In this example, client device 112 executes the client-side tool call. For example, client device 112 loads and edits the web page based on the route and arguments provided. The client device then forms a tool response, such as, “result”: {“status”: “The discount code was created successfully. You can view or edit this discount code at mystore.com/admin/discounts/blackfriday”. Client device 112 transmits a second HTTP request 322 including a RPC response to the RPC event 321 and client tool response to server 102.

Server 102 transmits the client tool response and corresponding conversation history in message 324 to LLM 104. Alternatively, the client tool response and conversation history are transmitted to LLM 104 in separate messages. LLM 104 forms an assistant in response to the prompt based on message 324. For example, LLM 104 generates and transmits assistant 326 to server 102. In the present example, assistant 326 may include, ‘The discount code was created successfully. You can view or edit this discount code at ‘mystore.com/admin/discounts/blackfriday.’ Next, server 102 transmits assistant 326 in HTTP response 328 to client device 112. Finally, server 102 terminates HTTP session 332 and closes the TCP connection, as indicated at numeral 329, and releases the communication port, e.g., port 80.

The work around described above introduces overhead/extra work for the system to support LLM client-side tool calling functionality. System resources (e.g., memory, computing resources) for initializing and establishing two server-client connections are consumed. A port/socket on server 102, e.g., port 80, is also monopolized for the full duration of the HTTP session 322, even while it may take client device 112 some period of time to complete execution of the requested client-side tool call and to send a response.

Additionally, this work around introduces complexity by extending the server-client protocol to include server-to-client procedure call and response messages and also requiring the server to implement a synchronization/message passing mechanism between two separate HTTP requests that happen concurrently.

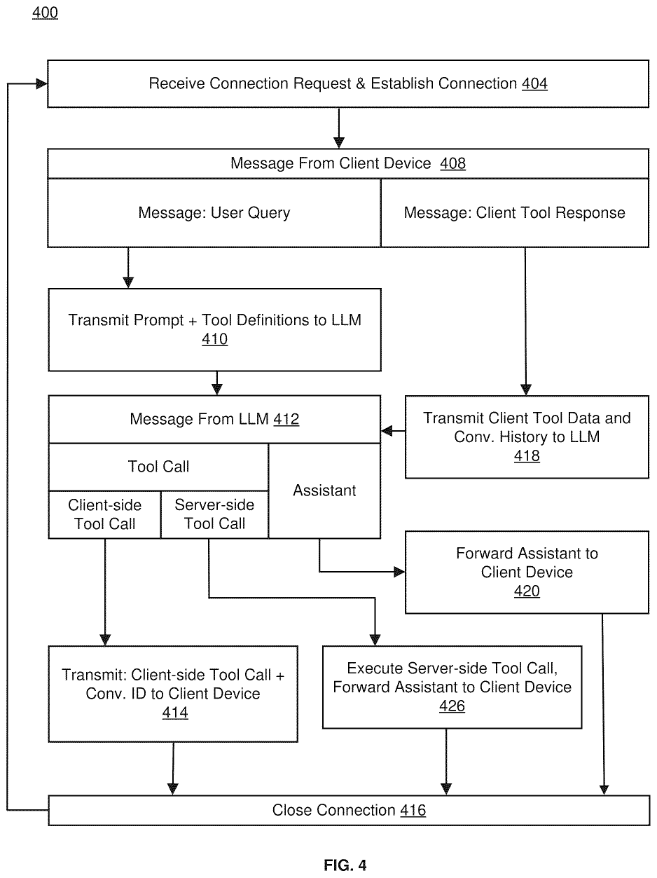

Illustrated in FIG. 4 is a simplified block diagram of an exemplary method 400 for calling a client tool by a LLM, i.e., client-side tool calling process, according to an embodiment. Method 400 may be implemented on one or more computing devices, for example, computing device 106. The method 400 may be carried out by one or more processors, for example, processor 120, based on processor-executable instructions stored in memory, e.g., memory 130, within the one or more computing devices. Method 400 is aimed at servicing a client-side tool call while minimizing processing resource utilization. Method 400 is described with reference to FIG. 1A and FIG. 1B.

Starting at block 404, method 400 includes receiving a request for, and establishing in response, a connection between a client and server. For example, client device 112 transmits a TCP connection request that specifies a server communication port, e.g., port 80 for HTTP messages, to server 102 initiating a TCP connection. Server 102 establishes a TCP connection with client device 112 and reserves the server communication port for communication over the TCP connection.

At block 408, method 400 includes receiving a message from the client device and determining, by the server, the type of message transmitted by the client device. Exemplary types of messages from a client device may include ‘user query’ and ‘client tool response’. A ‘user query’ message may correspond to a request or instruction for the LLM. A ‘client tool response’ message may correspond to a message including data obtained by the client device, or a result, (client tool response), in response to executing a tool call, (a client-side tool call), by the client device. Determining the type of message transmitted by the client device may be based on a conversation history object corresponding to a conversation identifier (ID) included in the message. A conversation history object may include conversation history of a prior exchange of messages between the server and LLM. Exemplary conversation history may include a prompt and a client-side tool call invoked by the LLM in response to the prompt, triggering the client device to execute the tool call.

In a first example, server 102 receives a message from client device 112 wherein the message includes a request or instruction for LLM 104. Server 102 determines the first message is a ‘user query’ message type. Accordingly, method 400 proceeds to block 410.

In a second example, server 102 receives a message from client device 112 wherein the message includes a conversation identifier, e.g., 450. In this example, server 102 fetches a conversation history object corresponding to the conversation ID, e.g., 450, from memory 130. The conversation history object may include a prompt, and a client-side tool call previously invoked by LLM 104 in response to the prompt. In this example, server 102 processes the conversation history object and determines the message type of the message from client device 112 is a ‘client tool response’ message-indicating the message from client device 112 includes a response to the client-side tool call. Accordingly, method 400 proceeds to block 418.

In some instances, method 400 may further include determining the message type of the message from the client device depending on the present state of the server. Exemplary server states may include ‘query’, and ‘tool response’. Server state ‘query’ indicates the server expects the next received message to include a user query for the LLM, i.e., a ‘user query’ message type. Server state ‘tool response’ indicates the server expects the next received message from the client device to include a ‘client tool response’.

For example, server 102 receives a message from client device 112 wherein the message includes a conversation identifier, e.g., 450. In this example, the conversation history object corresponding to conversation ID 450 includes conversation history as well as the present state of server 102. Server 102 fetches the conversation history object corresponding to the conversation ID, e.g., 450, from memory 130. Server 102 processes the conversation history object and determines the present state of the server is ‘tool response’ indicating the message type of the message from the client device is ‘client tool response’. In other words, the message from the client device is a response to a tool call. Accordingly, method 400 proceeds to block 418.

Now referring to block 410, method 400 includes transmitting a prompt to the LLM based on the message from the client device. Method 400 may also include transmitting a list of tool definitions to the LLM. Tool definitions may include functions executable by the server and functions executable by the client device. In a first example, server 102 transmits a message, including a prompt based on the user query and tool definitions, to LLM 104.

At block 412, method 400 includes receiving a message from the LLM and determining the type of the message received. Exemplary types of messages from an LLM include an ‘assistant’, a ‘server-side tool call’, and a ‘client-side tool call’. An ‘assistant’ message includes a LLM's response to a prompt. A ‘server-side tool call’ message includes a tool call for accessing/using functions executable by the server for performing a specific task, such as fetching data accessible by the server. Finally, a ‘client-side tool call’ includes a tool call for accessing/using functions executable by the client device for performing a specific task, such as fetching data accessible by the client device or performing an operation only executable by the client device.

For example, server 102 determines a message from LLM 104 includes a tool call, specifically, a client-side tool call. For instance, the message from LLM 104 includes a tool call for execution by client device 112. Accordingly, method 400 proceeds to block 414. In another example, server 102 determines the message from LLM 104 includes a tool call, specifically, a server-side tool call. For instance, the message from LLM 104 includes a tool call for execution by server 102. Accordingly, method 400 proceeds to block 426. In yet another example, the server processes the message from the LLM and determines the message includes an assistant. For instance, the message from LLM 104 includes a response to either a prompt, data obtained by the server in response to a server-side tool call, or data obtained by the client device, (client tool response), in response to executing a client-side tool call. Accordingly, method 400 proceeds to block 420.

Now referring to block 414, method 400 transmitting a conversation ID and the client-side tool call to the client device, wherein the client-side tool call is in response to receiving the ‘user query’ message from the client device. A conversation ID indicates conversation history between the server and LLM, for example, the prompt and client-side tool call transmitted by the LLM in response to the prompt. For example, server 102 initializes a conversation ID, e.g., 440, indicating the conversation history, for instance, the prompt transmitted to LLM 104, and corresponding client tool call transmitted from LLM 104 in response. In some instances, the conversation ID corresponds to an ongoing conversation between the server and LLM. Next, server 102 transmits the client-side tool call and respective conversation ID to client device 112. In some instances, the server state is set to ‘tool response’ indicating the next expected message to be received by server 102 includes a response to a client-side tool call, e.g., client tool response.

Upon receiving a client-side tool call and corresponding conversation ID from the server, the client device executes the tool call and fetches data or performs an operation as needed. The client device prepares and transmits a response to the tool call, including the fetched data, or result from performing an operation, i.e., client tool response, and corresponding conversation ID, to the server.

At block 416, method 400 includes closing the connection with the client device and releasing the communication port. For example, server 102 ends the HTTP session with client device 112, closes the TCP connection, and releases the communication port, e.g., port 80. In some instances, method 400 further includes, storing the conversation between the server and LLM in a conversation history object. For example, server 102 stores the latest prompt transmitted to LLM 104, the client-side tool call in response to the prompt, and corresponding conversation ID, e.g., 440, in a conversation history object in memory 130. In some instances, the state of the server is also stored in the conversation history object. For example, the present state of server 102, ‘tool response’, indicating the next expected message to be received by the server from the client device is a response to a client-side tool call, is also stored in the conversation history object in memory 130. Alternatively, the conversation history object and corresponding conversation ID are stored at block 414.

Existing client-server systems for LLM deployment closes the connection between the client device and server once an assistant is transmitted to the client in response to a user query. In contrast, method 400 includes closing the client-server connection subsequent to transmitting a tool call, i.e., a client-side tool call, to the client device, wherein the tool call is transmitted in response to the user query.

Method 400 returns to block 404 awaiting another connection request from the client device.

Now referring to block 426, method 400 includes executing a server-side tool call and transmitting data acquired by the server, i.e., server tool response, as well as corresponding conversation history to the LLM. At block 426, method 400 further includes receiving an assistant from the LLM in response to receiving the server tool response and transmitting the assistant to the client device. Method 400 may further include setting the server state to ‘query’, indicating the next expected message to be received by the server is a user query from the client device. For example, server 102 executes a server-side tool call transmitted by LLM 104, fetches the corresponding data, or result from performing an operation i.e., server tool response, and transmits the data, and corresponding conversation history, to LLM 104. Next, LLM 104 transmits an assistant to server 102 in response to receiving a response to the server tool response. Finally, server 102 transmits the assistant to client device 112 and sets the server state to ‘query’. In some instances, method 400 may include initializing a conversation ID indicating the conversation history (message exchange) between the server and LLM, Exemplary conversation history includes the prompt, server-side tool call, server tool response, and corresponding assistant.

At block 416, method 400 includes closing the connection with the client device and releasing the communication port. For example, server 102 ends the HTTP session with client device 112, closes the TCP connection, and releases the communication port, e.g., port 80. In some instances, method 400 further includes, storing the conversation between the server and LLM in a conversation history object. For example, server 102 stores the prompt, server-side tool call, server tool response, and corresponding assistant in a conversation history object in memory 130. In some instances, the state of the server is also stored in the conversation history object. For example, the present state of server 102, ‘query’, indicating the next expected message to be received by the server from the client device is a ‘user query’. Alternatively, the conversation history and corresponding conversation ID are stored in a conversation history object at block 426.

Now referring to block 420, method 400 includes transmitting the assistant received by the server to the client device. Method 400 may also include setting the server state to ‘query’ indicating the next expected message to be received by the server is a user query. For example, server 102 transmits the assistant message transmitted by LLM 104 to client device 112 and updates the server state of server 102 to ‘query’. In some instances, method 400 may include initializing a conversation ID indicating the conversation history (message exchange) between the server and LLM. Exemplary conversation history includes the prompt and assistant from the LLM in response to the prompt.

At block 416, method 400 includes closing the connection with the client device and releasing the communication port. For example, server 102 ends the HTTP session with client device 112, closes the TCP connection, and releases the communication port, e.g., port 80. In some instances, method 400 further includes, storing the conversation between the server and LLM and corresponding conversation ID in a conversation history object. For example, server 102 stores the prompt, assistant to the prompt, and corresponding conversation ID in a conversation history object in memory 130. In some instances, the state of the server is also stored in the conversation history object. For example, the present state of server 102, ‘query’, indicating the next expected message to be received by the server from the client device is a ‘user query’. Alternatively, the conversation history and corresponding conversation ID are stored in a conversation history object at block 420.

At block 418, method 400 includes transmitting the tool response, e.g., client tool response, and at least a portion of the corresponding conversation history, e.g., original prompt and client-side tool call, to the LLM. For example, server 102 fetches the conversation history object associated with a conversation ID included in the message from client device 112. Server 102 may fetch the conversation history object from memory 130. Next, server 102 transmits a message including the tool response, e.g., client tool response, and at least a portion of the conversation history, e.g., original prompt and client-side tool call, to LLM 104.

In an alternative embodiment of method 400, in replacement of, or in addition to HTTP, a custom application guaranteeing delivery of data between the client and server may be implemented over Universal Datagram Protocol (UDP) instead of HTTP over TCP.

Alternatively, client-server communication is implemented over a transport layer and/or network layer protocol other than TCP and/or TCP/IP. While TCP/IP is the dominant protocol suite for communication over the internet, other networks/protocols exist. Specific and non-limiting example of another network/protocol includes QUIC (Quick UDP Connection Protocol),

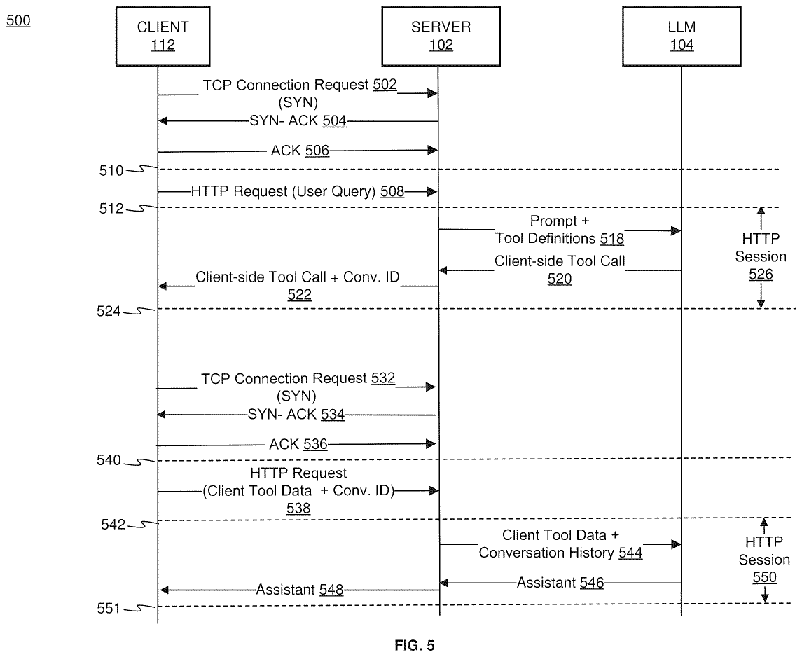

Referring now to FIG. 5A shown is an exemplary message sequence diagram 500 associated with a LLM client-side tool calling process according to an embodiment. Messages are described with reference to FIG. 1A and FIG. 1B.

A user inputs a first user query into a user interface of client device 112 for processing by LLM 104. For instance, a user a enters a first user query into a text box of a GUI integrated with a LLM application. For example, the LLM is used for helping users of an e-commerce platform create and manage online stores. An exemplary user query may include, ‘Help me create a 15% discount code for the Black Friday sale’. Client device 112 transmits a TCP connection request 502, including a server communication port, to server 102 initiating a TCP connection. Client device 112 and server 102 exchange a 3-way TCP three-way handshake (SYN 502, SYN-ACK 504, and SYN 506). The server communication port is reserved for the TCP connection e.g., port 80 for HTTP messages, and a TCP connection is established, as indicated by numeral 510. A HTTP request message 508, including the first user query for LLM 104, is transmitted by client device 112 to server 102 over the TCP connection. In response, server 102 begins HTTP session 526, as indicated at reference numeral 512.

Based on the first user query, server 102 constructs a prompt for processing by LLM 104. Server 102 transmits message 518, including the prompt and a list of tool definitions of functions executable by server 102 and client device 112, to LLM 104. Alternatively, the prompt and tool definitions are transmitted to server 102 in separate messages. LLM 104 analyzes the prompt and determines that information from an external source, or an operation only executable by an external source, e.g., client device 112, is needed to provide a response (i.e., assistant) to the prompt. In particular, LLM 104 identifies a specific client tool as an appropriate function for obtaining the needed information and/or carrying out an instruction requested by the user. In the present example, the LLM may identify a client-side tool called, ‘fill_form_locally’ as an appropriate tool for providing a response to the user query, ‘Help me create a 15% discount code for the Black Friday sale’. LLM 104 transmits a tool call 520, including a client-side tool call, to server 102. Client-side tool call 520 may include the tool name and required arguments/fields, such as ‘fill_form_locally’ with arguments {‘route’:“mystore.com/admin/discounts/create”, ‘parameter1_name’:“discount_name”, ‘parameter1_value’:“blackfriday”, ‘parameter2_name’:“discount_type”,‘parameter2_value’:“percentage”, ‘paramater3_name’: “discount_value”, ‘parameter3_value’: “15%”}.

Next, server 102 processes client-side tool call 520 and determines the message includes a tool call intended for execution by client device 112, i.e., client-side tool call. Server 102 initializes a first conversation ID and transmits message 522 including the client-side tool call and corresponding first conversation ID to client device 112.

Subsequent to transmitting message 522, server 102 stores a first conversation history object, including the conversation history and the first conversation ID in memory 130. Conversation history may include prompt of message 518 and client-side tool call 520. Next, server 102 ends HTTP session 526, closes the TCP session with client device 112 as indicated at numeral 524, and releases the TCP port, e.g., port 80.

Client device 112 executes the client-side tool call. For example, client device 112 loads and edits a web page based on the route and arguments provided. The client device 112 then forms a tool response, such as, “result”: {“status”: “The discount code was created successfully. You can view or edit this discount code at ‘mystore.com/admin/discounts/blackfriday’. Next, client device 112 transmits a second TCP request 532, including a server communication port, to server 102 initiating a second TCP connection. Client device 112 and server 102 exchange a 3-way TCP three-way handshake (SYN 532, SYN-ACK 534, and SYN 536). The server communication port is reserved for the TCP connection e.g., port 80 for HTTP messages, and a TCP connection is established, as indicated by numeral 540. A HTTP request message 538, including the client tool response and corresponding first conversation ID, is transmitted by client device 112 to server 102 over the TCP connection. In response, server 102 begins HTTP session 550 with client device 112, as indicated at reference numeral 542.

Server 102 fetches the first conversation history object corresponding to the first conversation ID provided in HTTP request message 538 from memory 130. Next, server 102 processes the retrieved conversation history for determining that HTTP request message 538 includes a tool response, i.e., client tool response, in response to the client-side tool call.

Next, server 102 transmits the client tool response and at least a portion of the conversation history, for instance, corresponding prompt and client-side tool call, in message 544 to LLM 104. LLM 104 processes message 544 and transmits an assistant message 546 to server 102 in response to message 544. In the present example, assistant message 546 may include, ‘The discount code was created successfully. You can view or edit this discount code at ‘mystore.com/admin/discounts/blackfriday.’ Next, server 102 transmits the assistant message from LLM 104 in message 548. Finally, server 102 ends HTTP session 550, closes the TCP session with client device 112 as indicated at numeral 551, and releases the TCP port, e.g., port 80.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an embodiment, should be understood to mean that the value, condition or characteristic is defined within tolerances that are acceptable for the proper operation of this embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

A person skilled in the art will understand that embodiments of this application may be provided as a method, an apparatus (or system), a computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It will be understood that a person skilled in the art may make various modifications and variations to this application without departing from the scope of this application. This application is intended to cover these modifications and variations of this application provided that they fall within the scope of protection defined by the following claims and their equivalent technologies.

Throughout the present disclosure, a processor, a processor system, an application processor, a baseband processor, a processor circuit, or a processor core may be collectively referred to as a processor. A processor may include one or more of a central processing unit (CPU), a digital signal processor (DSP), a microprocessor unit (MPU), a microcontroller unit, (MCU), a graphics processing unit (GPU), a field programmable gate array (FPGA), an artificial intelligence (AI) processor, or a neural network processing unit (NPU), or a combination of at least two of these integrated circuit forms.

Throughout the present disclosure, a memory may include one or more of the following storage media: a RAM, a static random access memory (SRAM), a dynamic random access memory (DRAM), a phase-change memory (PCM), a resistive random access memory (ReRAM), a magnetoresistive random access memory (MRAM), a ferroelectric random access memory (FRAM), a cache, a register, a read-only memory (ROM), a flash memory, an erasable programmable read-only memory (EPROM), a hard disk, and/or the like. In an example, the computer program instructions used to execute embodiments contained herein may be stored in a non-volatile memory. When a terminal runs, part or all of corresponding computer program instructions may be loaded into a memory that has a higher transmission speed with a corresponding processor, for example, the instructions may be loaded into at least a part of a memory such that the processor executes the computer program instructions to perform the steps in of embodiments described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A computer-implemented method, comprising:
establishing, at a server, a first connection between a client device and the server in response to receiving a first request from the client device;
transmitting, based on a first message from the client device, a first prompt from the server to a large language model (LLM) and, in response, receiving a tool call from the LLM;
determining that the tool call is a client-side tool call and transmitting, via the first connection, the tool call and a conversation identifier to the client device in response to the first message;
closing the first connection and storing a conversation history object in memory at the server in association with the conversation identifier;
establishing, at the server, a second connection with the client device in response to receiving, from the client device, a second request;
retrieving the conversation history object from memory based on the conversation identifier in response to receiving, from the client device, a second message and the conversation identifier;
determining, based in part on the conversation history object, that the second message includes a tool response in reply to the tool call and transmitting to the LLM a third message including the tool response and at least a portion of the conversation history object; and
receiving a first assistant message from the LLM in reply to the third message and transmitting the first assistant message to the client device.

2. The method according to claim 1, wherein determining that the tool call is a client-side tool call includes processing, by the server, the tool call and determining it references a function executable by the client device.

3. The method according to claim 1, wherein determining the second message includes a tool response in reply to the tool call based in part on the conversation history object includes determining, from the conversation history object, that a next expected response from the client device is a tool response type message.

4. The method according to claim 1, wherein closing the first connection occurs without transmitting an assistant response message in reply to the first message from the client device.

5. The method according to claim 1, further comprising executing, at the client device, a tool function in response to receipt of the tool call from the server and wherein the tool function produces content for the tool response.

6. The method according to claim 1, further comprising:
establishing, at the server, a third connection between the client device and the server in response to receiving a third request from the client device and a fourth message containing a second prompt;
assigning a further conversation identifier and initializing a further conversation history object for storing conversation history; and
transmitting the third message to the LLM, receiving a second assistant message from the LLM in reply to the third message, and transmitting the second assistant message and the further conversation identifier to the client device.

7. The method according to claim 1, further including opening a HTTP session over the first connection between the client device and the server.

8. The method according to claim 7, wherein closing the first connection releases a port on the server associated with the HTTP session.

9. A computing device comprising:
one or more processors; and
at least one memory storing processor-executable instructions,
wherein the processor-executable instructions, when executed, are to cause the one or more processors to:
establish, at a server, a first connection with a client device in response to receiving a first request from the client device;
transmit, based on a first message from the client device, a first prompt from the server to a large language model (LLM) and, in response, receive a tool call from the LLM;
determine that the tool call is a client-side tool call and transmit, via the first connection, the tool call and a conversation identifier to the client device in response to the first message;
close the first connection and store a conversation history object in memory in association with the conversation identifier;
open a second connection with the client device in response to receiving, from the client device, a second request;
retrieve the conversation history object from memory based on the conversation identifier in response to receiving, from the client device, a second message and the conversation identifier;
determine, based in part on the conversation history object, that the second message includes a tool response in reply to the tool call and transmit to the LLM a third message including the tool response and at least a portion of conversation history; and
receive a first assistant message from the LLM in reply to the third message and transmits the first assistant message to the client device.

10. The computing device of claim 9, wherein determining that the tool call is a client-side tool call includes processing the tool call and determining it references a function executable by the client device.

11. The computing device of claim 9, wherein determining the second message includes a tool response in reply to the tool call based in part on the conversation history object includes determining, from the conversation history, that a next expected response from the client device is a tool response type message.

12. The computing device of claim 9, wherein closing the first connection occurs without transmitting an assistant response message in reply to the first message from the client device.

13. The computing device of claim 9, wherein the processor-executable instructions, when executed, are to further cause the one or more processors to:
establish, at the server, a third connection between the client device and the server in response to receiving a third request from the client device and a fourth message containing a second prompt;
assign a further conversation identifier and initialize a further conversation history object for storing conversation history; and
transmit the third message to the LLM, receive a second assistant message from the LLM in reply to the third message, and transmit the second assistant message and the further conversation identifier to the client device.

14. The computing device of claim 9, wherein the processor-executable instructions, when executed, are to further cause the one or more processors to:
open a HTTP session over the first connection between the client device and the server.

15. The computing device of claim 14, wherein closing the first connection releases a port on the server associated with the HTTP session.

16. A non-transitory computer-readable medium storing processor-executable instructions that, when executed by one or more processors, are to cause the one or more processors to:
establish, at a server, a first connection between a client device and the server in response to receiving a first request from the client device;
transmit, based on a first message from the client device, a first prompt from the server to a large language model (LLM) and, in response, receive a tool call from the LLM;
determine that the tool call is a client-side tool call and transmit, via the first connection, the tool call and a conversation identifier to the client device in response to the first message;
close the first connection and store a conversation history object in memory at the server in association with the conversation identifier;
open, at the server, a second connection with the client device in response to receiving, from the client device, a second request;
retrieve the conversation history object from memory based on the conversation identifier in response to receiving, from the client device, a second message and the conversation identifier;
determine, based in part on the conversation history object, that the second message includes a tool response in reply to the tool call and transmit to the LLM a third message including the tool response and at least a portion of conversation history; and
receive a first assistant message from the LLM in reply to the third message and transmits the first assistant message to the client device.

17. The non-transitory computer-readable medium of claim 16 wherein determining that the tool call is a client-side tool call includes processing the tool call and determining it references a function executable by the client device.

18. The non-transitory computer-readable medium of claim 16 wherein determining the second message includes a tool response in reply to the tool call based in part on the conversation history object includes determining, from the conversation history, that a next expected response from the client device is a tool response type message.

19. The non-transitory computer-readable medium of claim 16 wherein closing the first connection occurs without transmitting an assistant response message in reply to the first message from the client device.

20. The non-transitory computer-readable medium of claim 16 wherein the processor-executable instructions further cause the one or more processors to:
establish, at the server, a third connection between the client device and the server in response to receiving a third request from the client device and a fourth message containing a second prompt;
assign a further conversation identifier and initialize a further conversation history object for storing conversation history; and
transmit the third message to the LLM, receive a second assistant message from the LLM in reply to the third message, and transmit the second assistant message and the further conversation identifier to the client device.
